(19) United States
(12) Patent Application Publication
(10) Pub. No.: US 2010/0259240 A1
(43) Pub. Date: Oct. 14, 2010

(54) Bridgeless PFC converter

(75) Inventor: Slobodan Cuk, Laguna Niguel, CA (US)

Correspondence Address: CUKS , LLC, 35 TESLA, SUITE 350, IRVINE, CA, 92618, US

(73) Assignee: CUKS, LLC

(21) Appl. No.: 12/798,682

(22) Filed: Apr. 10, 2010

Related U.S. Application Data
(60) Provisional application No. 61/212,430, filed on Apr. 11, 2009.

(51) Int. Cl. G05F 5/00

(52) U.S. Cl. 323/299

(57) ABSTRACT

A truly Bridgeless PFC converter is provided which eliminates the four-diode bridge rectifier and operates directly from the AC line to result in high-efficiency, small size and low cost solution for Power Factor Correction applications.

### CROSS-REFERENCE TO RELATED APPLICATIONS

Provisional U.S. Patent Application No. 61/212,430

Filed on Apr. 11, 2009

Applicant: Slobodan Cuk

Title: Bridgeless PFC Converter

Confirmation Number: 9358

### FIELD OF THE INVENTION

This invention relates to the field of switching DC-to-DC converters and more specifically to their use as a Power Factor Correction (PFC) converter part of an AC-DC converter. When suitably controlled PFC converters force the input AC current wave shape to be sinusoidal and in phase, and proportional with input AC voltage thus resulting in desirable low harmonic content and maximum available real power drawn from the AC line.

This invention also relates to the DC-DC converters, which have DC voltage step-up characteristic as this is a desired prerequisite for performing Power Factor Correction function. Prior-art boost converter is the most often used converter for that application. As the front-end diode bridge is inefficient, many variants of the boost DC-DC converter are proposed with an objective to reduce diode bridge rectification to only two diodes instead of the four diodes of the full-bridge and thereby improve efficiency, such as a dual boost converter and a number of its variants. The boost converter does not have an isolated variant; so all PFC converters based on the boost converter are limited to non-isolated PFC applications.

### BRIEF DESCRIPTION OF THE DRAWINGS

FIG. 1a illustrates the prior-art AC-DC converter with full-bridge rectifier and large capacitor and

FIG. 1b illustrates the bad Power Factor of the AC-DC converter in FIG. 1a.

FIG. 2a illustrates the prior-art method of Power Factor Correction by use of the switching DC-DC converters, FIG. 2b illustrates the AC line voltage and AC line current drawn from the PFC converter of FIG. 2a and FIG. 2c illustrates the output of the full-bridge rectifier of FIG. 2a.

FIG. 3a shows a prior-art boost converter, FIG. 3b shows the switch states of the boost converter in FIG. 3a and FIG. 3c shows a DC voltage step-up gain characteristic of the boost converter of FIG. 3a.

FIG. 4 shows the prior-art boost converter used together with the full-bridge rectifier as a Power Factor Corrector.

FIG. 5 shows a prior-art PFC converter.

FIG. 6 shows a prior-art PFC converter.

FIG. 7 shows a prior-art PFC converter.

FIG. 8 shows a prior-art PFC converter.

FIG. 9 shows a prior-art PFC converter.

FIG. 10 illustrates a new Bridgeless Power Factor Correction method.

FIG. 11a illustrates a new Bridgeless Power Factor Converter with a controllable switch S_{VB} that must be voltage bi-directional and operate in first and third quadrant and FIG. 11b illustrates the implementation of the switch S_{VG} in converter of FIG. 11a with the two N-channel MOSFET switches.

FIG. 12a shows a block diagram of the prior-art PFC control circuit of the converter in FIG. 2a and FIG. 12b shows a block diagram of the control method used for new Bridgeless PFC converter of FIG. 11b.

FIG. 13a shows the AC line input voltage for converter in FIG. 11a and FIG. 13b shows AC line current drawn by the Bridgeless PFC converter of FIG. 11b displaying the input high frequency switching current of the Bridgeless PFC converter.

FIG. 14a illustrates operation of the Bridgeless PFC converter for positive input voltage and FIG. 14b illustrates the switch states for the converter of FIG. 14a.

FIG. 15a illustrates operation of the Bridgeless PFC converter for negative input voltage and

FIG. 15b illustrates the switch states for the converter of FIG. 15a.

FIG. 16a illustrates the resonant circuit during ON-time interval DT_{S}, FIG. 16b illustrates the current of the floating capacitor C and FIG. 16c illustrates the resonant ripple voltage on the floating capacitor C during ON-time interval DT_{S}.

FIG. 17a illustrates capacitor current waveform when a variable ON-time interval is equal to constant OFF-time interval, FIG. 17b illustrates capacitor current waveform when a variable ON-time interval is two-times longer than constant OFF-time interval and FIG. 17c illustrates capacitor current waveform when a variable ON-time interval is one half of the constant OFF-time interval.

FIG. 18 shows the experimental AC line voltage (top trace) and AC line current (bottom trace) measured on the 400 W bridgeless PFC converter of present invention.

FIG. 19a illustrates the efficiency of the 400 W Bridgeless PFC prototype over the input AC voltage range and FIG. 19b illustrates the power losses of the 400 W Bridgeless PFC prototype over the input AC voltage range.

### PRIOR ART

### Introduction to Power Factor Correction

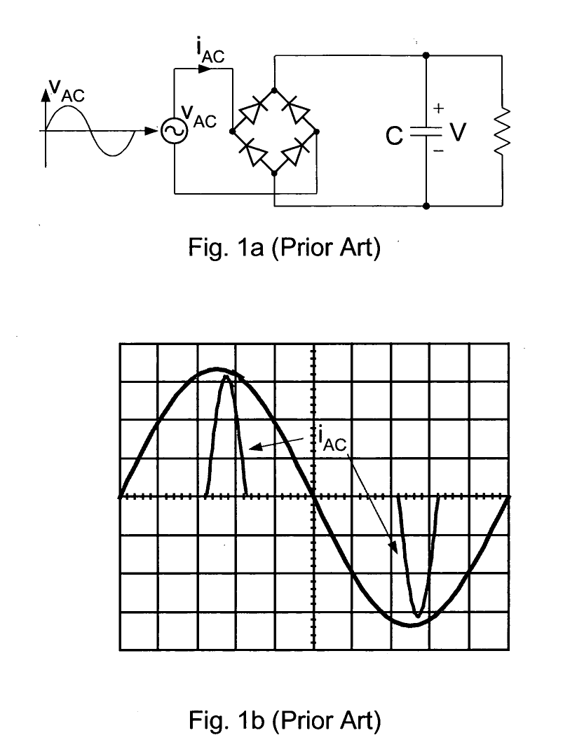

Utility power is AC (alternating voltage and alternating current), while the power consumed by most electrical and electronic equipment is DC (DC voltage and DC current), hence the need for an AC-to-DC power conversion. Simple method used in the past prior to advent of PFC converters was to rectify AC line voltage with a full bridge (four-diodes) rectifier to charge a large output capacitor so that a small ripple voltage would be obtained on DC voltage output V as shown in FIG. 1a. As the current from the AC line is only drawn during a short time interval around the peak of the input AC line voltage (while its value is higher than the output DC voltage V) shown in FIG. 1b, this simple method has two fundamental drawbacks:

a) a lot of high frequency harmonics are generated due to the narrow pulse of the input current, which is not acceptable as the harmonic content of AC line is now regulated by mandatory regulations.
b) very low power factor of PF=0.6, which results in the poor utilization of the available power on the utility grid as the large reactive power only generates wasteful losses in transmission lines without delivering the actual (active) power to the load.

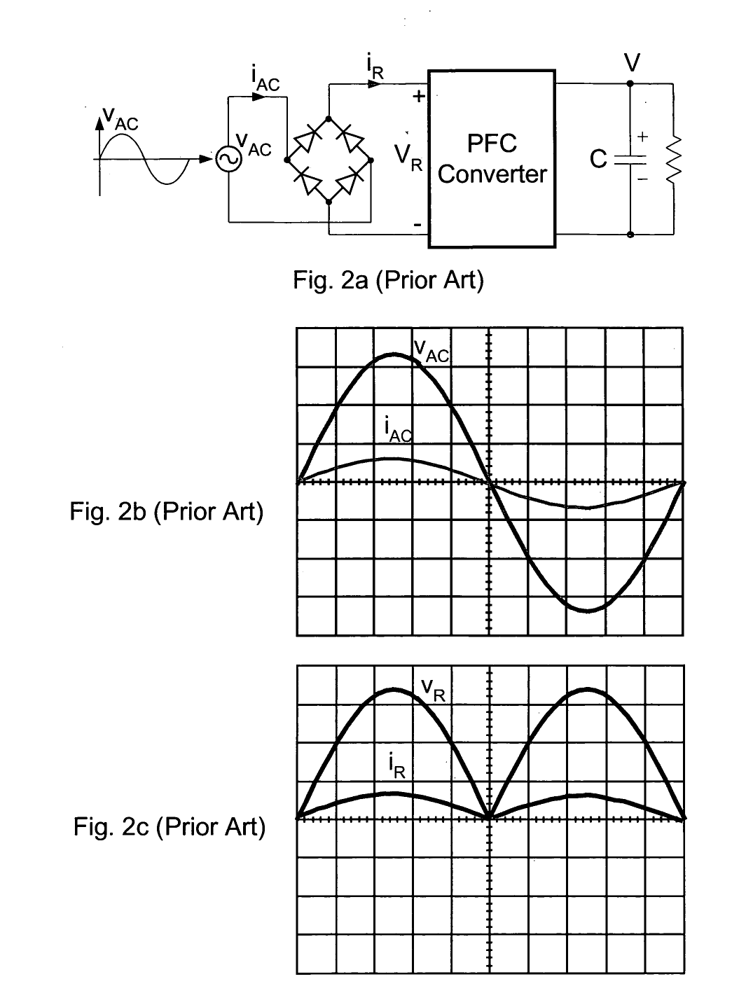

For the above reasons, for power higher than 75W and depending on type of electrical equipment, some form of Power Factor Correction is mandated by regulations. Hence, the large capacitor C is moved from output of bridge rectifier in FIG. 1a to the output of the PFC converter as illustrated in FIG. 2a. With the capacitor C removed, the purpose of the full-bridge rectifier in FIG. 2a is to convert the alternating low frequency 60 Hz AC voltage v_{AC} and alternating AC current I_{AC} of FIG. 2b into a rectified voltage v_{R} and rectified current I_{R} shown in FIG. 2c so that the PFC converter is presented with only a positive polarity of the input voltage (rectified AC voltage) and positive input current (rectified input current). All present DC-DC converters can accept only one polarity of the input voltage and current. Therefore, the full-bridge rectifier is necessary to accommodate that fundamental limitation of the present DC-DC converters. The PFC converter in FIG. 2a is therefore any DC-DC converter with a DC voltage step-up characteristic, which is required for performing PFC function. Instead of usual control and regulation of the output DC voltage, PFC converter is now controlled in such a way to make rectified input current i_{R} proportional to rectified input voltage v_{R} and thereby impose the same relationship to their AC equivalents.

The PFC converter with aid of bridge rectifier effectively draws a sinusoidal input line current i_{AC} which is ideally in phase with sinusoidal input voltage v_{AC} to result in a power factor of PF=1 as illustrated in FIG. 2b. This therefore ideally eliminates all higher frequency harmonics and delivers full active power capability of the AC line. Therefore, the full-bridge rectifier is an indispensable part of the present AC-DC converters using PFC converter based on exiting DC-DC converters.

### Prior Art Power Factor Converters

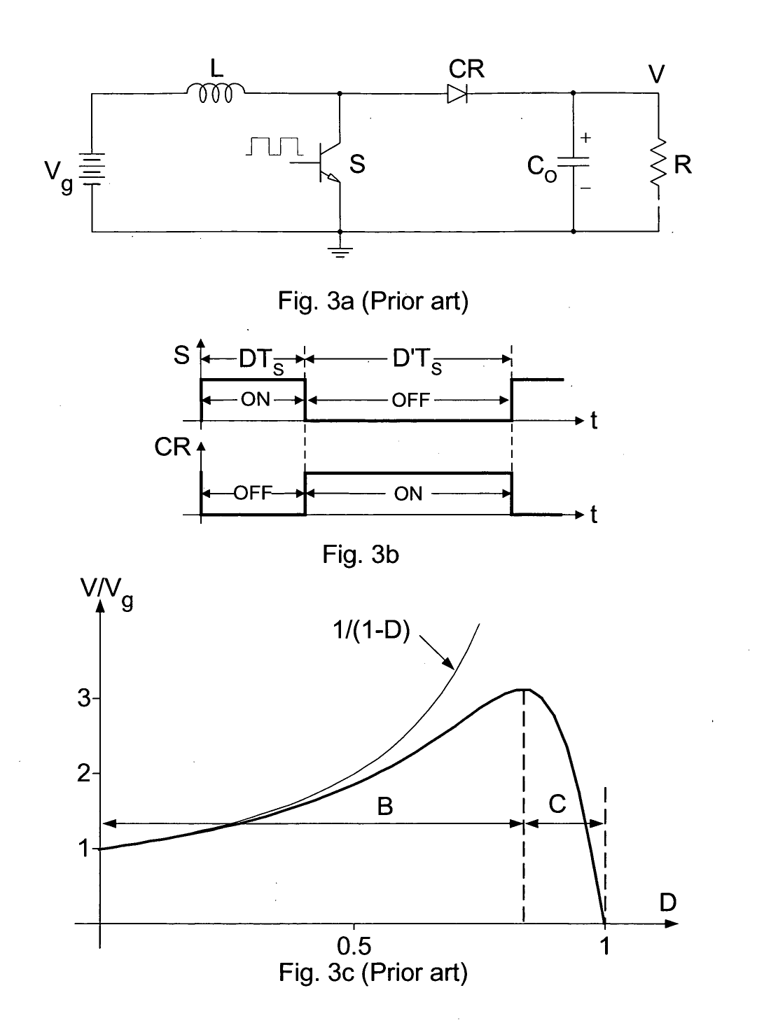

A number of prior-art PFC converters are reviewed here and their advantages and drawbacks analyzed briefly. The most common DC-DC converter used as a PFC converter in FIG. 3a is a boost converter.

### Prior-Art Boost Converter

The prior-art PWM boost converter is shown in FIG. 3a and its switching states in FIG. 3b. Its idealized DC voltage conversion ratio V=V_{g}/(1−D) is shown in thin lines in FIG. 3c, where D is duty ratio of the switch S and designates the fractional ON-time of this switch relative to the total switching period T_{S}. The thick line illustrates the actual DC voltage gain in presence of losses.

This converter is polarity non-inverting that is, for positive input voltage it generates positive output voltage relative to the common ground terminal. Therefore, this converter is not capable to accept an alternating input voltage, which might change its polarity, from positive to negative and vice verse with respect to ground and still generate a positive output DC voltage V. In fact, all presently known DC-DC single-stage power converters have the same limitations of one voltage polarity on input. As explained earlier, this is why front-end bridge rectifier is needed to accommodate that shortcoming of the boost and other DC-DC converters.

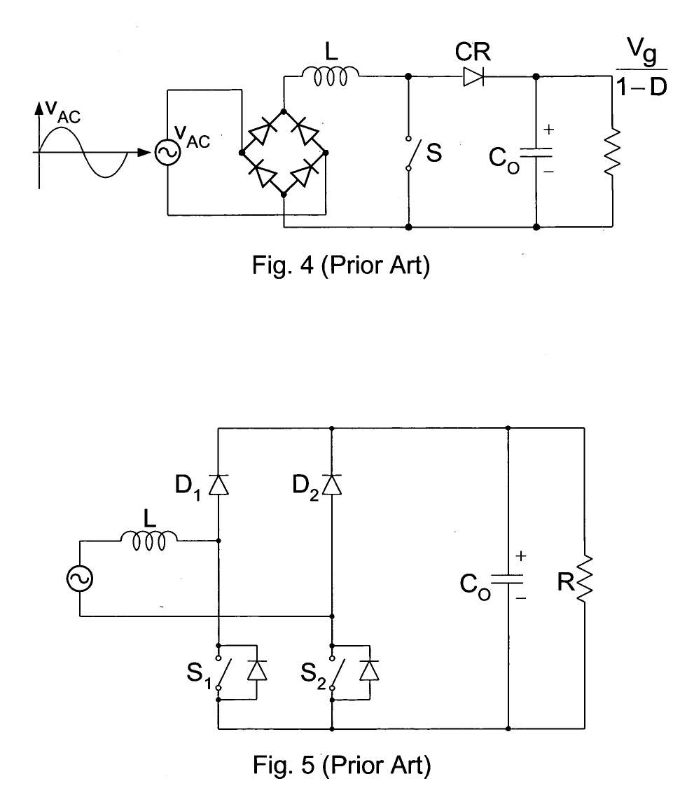

Shown in FIG. 4 is a prior-art boost converter used as a PFC converter with its indispensable front-end full bridge rectifier. In addition to boost converter losses, the input alternating current must pass also through the two diodes of the bridge rectifier for either positive or negative part of AC cycle. The corresponding two-diode voltage drops for low AC line voltage of 85V_{AC} result in additional 3% losses making a total conversion losses of around 6%. Clearly, eliminating the full-bridge rectifier and operating directly from the AC line would result in a true bridgeless PFC converter with several benefits:

a) High losses of the full-bridge rectifier would be eliminated;

b) Size and cost would be reduced.

A number of prior-art PFC converters were proposed to remedy that problem and reduce the number of diode voltage drops in the power path of the four diode bridge rectifier and thus to increase the overall efficiency. However, they all failed to achieve the desirable goal of eliminating input bridge as they were all based on the various modifications of the boost converter of FIG. 3a, which can operate only from the positive polarity of the input voltage. The only way to eliminate the full-bridge converter entirely is to use for a PFC converter, a converter which is capable of accepting a bipolar input voltage (that is either positive or negative input DC voltage and generate an output voltage of only one polarity. Until present invention, there were no DC-DC converters (with any DC conversion gain), which met that objective.

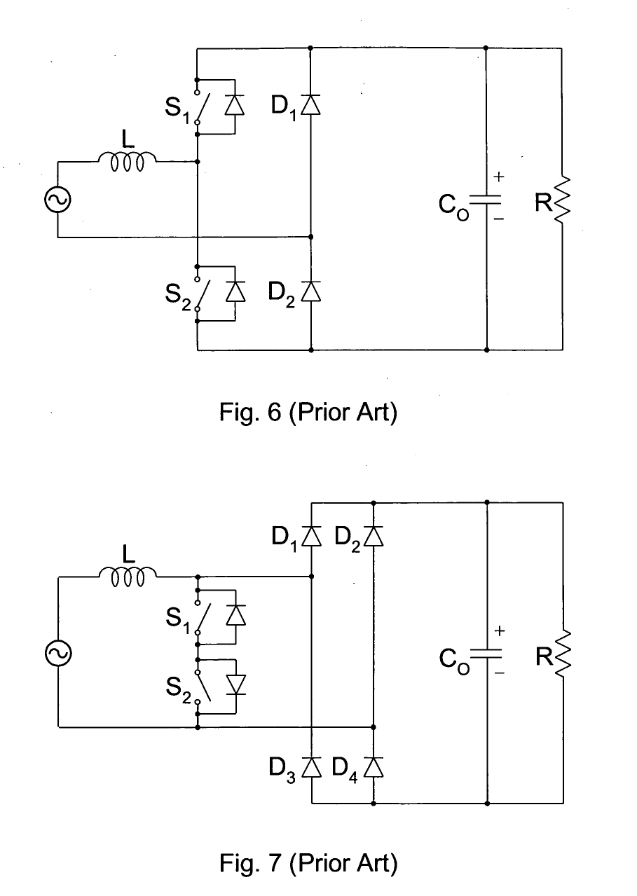

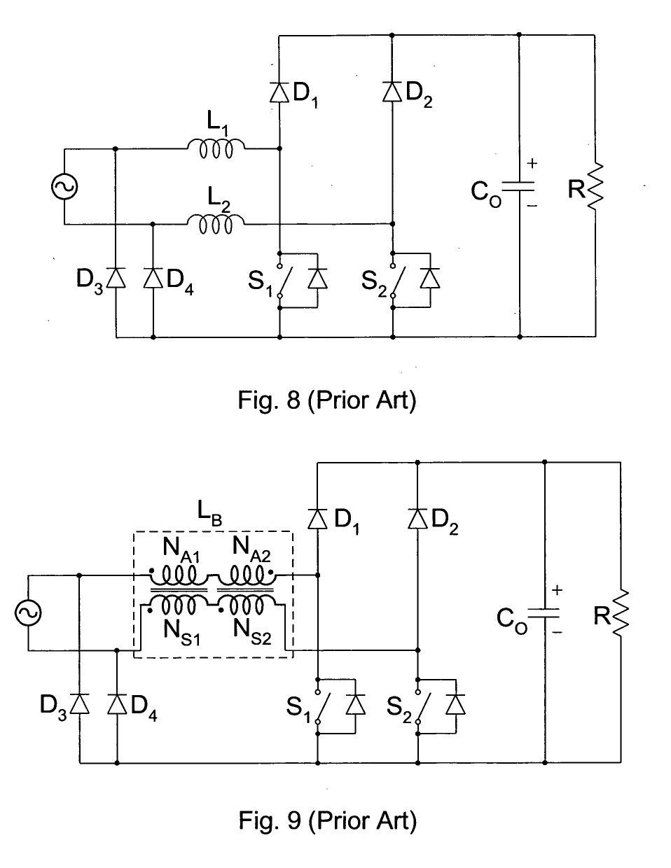

Therefore, in all prior-art configurations of FIG. 5, FIG. 6, FIG. 7, FIG. 8, and FIG. 9, one may discover the additional diode voltage drops in the power paths or extra conduction power loss. For example, the prior-art converter of FIG. 5 although appearing to have smaller number of semiconductor switches, the two controlling switches S₁ and S₂ must be for one half of AC cycle ON all the time (not in pulsed mode) thereby both resulting in extra losses. The prior art-converter of FIG. 6 has additional problem that it is limited to operation in Discontinuous Inductor Current mode. The prior-art converter of FIG. 7 appears to have eliminated the front-end full bridge rectifier. Yet, the closer examination of the converter topology reveals that it does have effectively a full bridge rectifier consisting of four diodes but now on the high-switching frequency side of 100 kHz instead of at line frequency at 60 Hz. This effectively results in two diode voltage drops in series for either positive or negative input voltage. Thus, once again, effectively one extra diode voltage drop is encountered for either positive or negative input voltage. Additional disadvantage is that all four diodes are high switching frequency diodes and not low AC line 60 Hz frequency rectifiers. Prior-art converter of FIG. 8 employs two complete boost converters, one for each of the AC input voltage cycle and with two additional low frequency 60 Hz diode rectifiers D₃ and D₄. Therefore, in addition to the reduced efficiency due to additional diode voltage drops (only two diodes in the full-bridge are eliminated), it also suffers from doubling the cost in comparison to the previous prior-art implementations. Finally, this double-boost converter as it is known in the field, has also two inductors, as opposed to single inductor of previous prior-art PFC converters. Thus, the components in double-boost converter of FIG. 8 are poorly utilized, as they are used only half of the time while during the other half time they idle resulting in serious penalty in weight, size and cost. The prior-art converter of FIG. 9 attempts to remedy that situation by improving the magnetics core utilization through the use of two coupled inductor magnetics. Yet, the above review of the prior-art clearly indicates that double-boost converters of FIG. 8, as well as other prior-art PFC converters could not be classified as bridgeless converters, since they encounter in one way or another an extra diode voltage drop in its power path and preserve at least two rectifiers of the four rectifier full-bridge for its operation. The present invention eliminates entirely the full-bridge rectifier as disclosed herein and is therefore a true Bridgeless PFC converter.

### SUMMARY OF THE INVENTION

### New Bridgeless PFC Converter Method

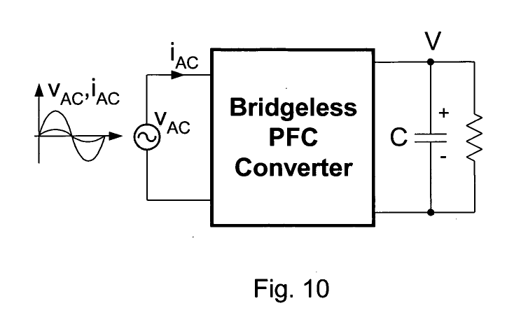

The bridgeless PFC method is illustrated in FIG. 10 in which Bridgeless PFC converter is operated directly from the AC line and converting input AC power directly to output DC voltage and power, while drawing the sinusoidal current from the line proportional and in phase with line voltage. Clearly, the Bridgeless PFC converter must fulfill some basic prerequisites such as:

1. Switching converter must be capable of accepting either the positive or the negative polarity of the input voltage;

2. Switching converter must act as a folding stage, which will for either polarity of the input voltage generate a positive polarity output voltage;

3. DC-DC converter must have a DC voltage step-up gain characteristic, such as 1/(1−D) so that it can convert a sinusoidal input voltage varying between zero voltage and peak input voltage of 150V (for 110 VAC line) to a higher DC voltage, such as 200VDC or more.

4. The DC conversion ratio of the switching converter must be equal whether the input voltage is positive or negative.

In addition to these requirements imposed on the switching power processing stage, there is also need for modified control of the input current of the PFC converter since in boost PFC converter the input voltage and current were already folded AC line voltage and current, while in the new method of FIG. 10, both line voltage and line current are AC quantity and not folded.

### New Bridgeless PFC Converter

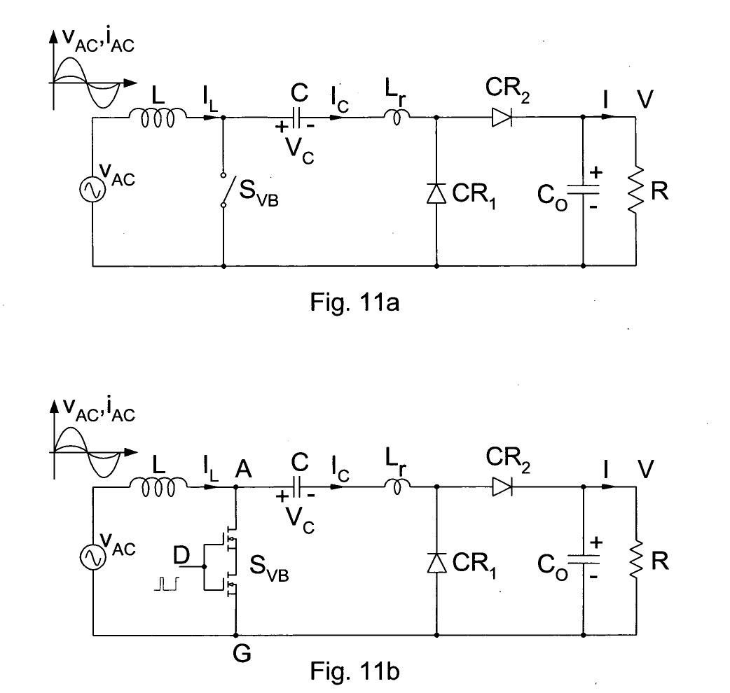

A new type of switching converter shown in FIG. 11a, which satisfies the conditions for bridgeless PFC conversion consists of three switches: one controllable voltage bi-directional switch S_{VB}, and two current rectifiers CR₁ and CR₂. The main controlling switch S_{VB} is a Voltage Bi-directional (VB) switch which is capable of blocking the voltage of either polarity in its OFF state, and in its ON state conducts the current in appropriate direction depending on the polarity of the input DC voltage. For example, for positive input voltage, S_{VB} switch conducts current from node A to G (FIG. 11b), while for negative input voltage it conducts the current in opposite directions, from node G to node A. As currently there exist not a single semiconductor switch, which can perform this function, a composite semiconductor switch consisting of two N-channel MOSFET transistors as illustrated in FIG. 11b can be used at present to perform its function.

### Prior-art Boost PFC Control

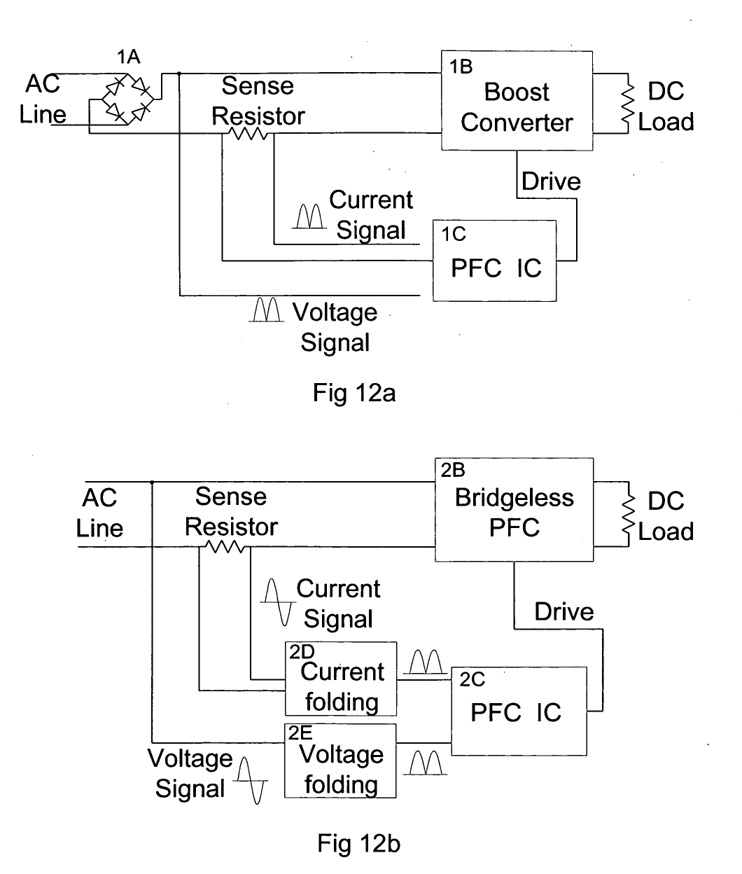

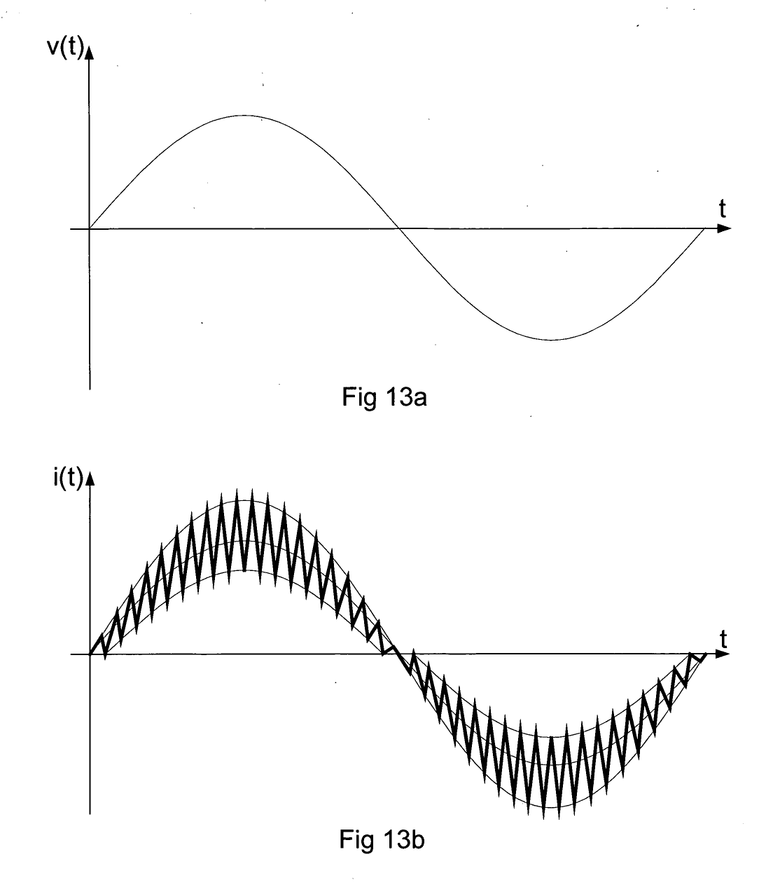

Block diagram of control of the prior-art boost PFC converter of FIG. 4 is shown in FIG. 12a. The bridge rectifier (1A) folds AC line voltage and AC line current into a uni-directional voltage and uni-directional current since the boost converter and other prior-art converters only accept input voltage of one polarity. The boost converter with the proper control converts the folded input line voltage and current into a DC output voltage and current. The control circuit uses a prior-art PFC control chip in the following way. The rectified sine-wave voltage signal is sent to PFC IC chip as a reference signal. A current sense resistor is used to sense the input current. The PFC IC chip compares the rectified current signal waveform to the voltage signal waveform and adjusts the duty ratio of the boost converter to make the current signal match the voltage signal. As a result the input current (low frequency average of the boost inductor current) is made proportional and in phase with voltage to result in the line current waveform as in FIG. 13b.

### New Bridgeless PFC Control

The bridgeless PFC converter does not have a bridge rectifier so the control is modified as illustrated by the block diagram of FIG. 12b. The AC line is sent directly to the bridgeless PFC converter (2B) to convert input sine wave to DC output.

The following is the modification of the control circuit, which still makes it possible to use the standard PFC control chip for the control of Bridgeless PFC converter. The input sine-wave voltage signal is passed through a signal processing folding stage (2E) before being sent to the PFC IC chip (2C) as a reference. A current sense resistor is used to sense the input current. This signal is a sine-wave signal as well. Another folding stage (2D) converts the sine wave current signal into a rectified sine wave, which is then sent to PFC IC chip. The PFC IC chip compares this “folded” voltage signal, and adjusts the duty ratio of the new Bridgeless PFC converter to make the current signal match the voltage signal. Once again, the current drawn from the AC line is as in FIG. 13b whose low frequency sinusoidal average follows the input line AC voltage of FIG. 13a.

### DETAILED DESCRIPTION OF THE INVENTION

One of the key characteristics of the new Bridgeless PFC converter of FIG. 11a and FIG. 11b is that the switching converter is inherently capable of operating from either positive or negative input voltage. Thus we will explain separately first the operation from the positive input voltage and then from the negative input voltage.

Operation from Positive Input Voltage Polarity

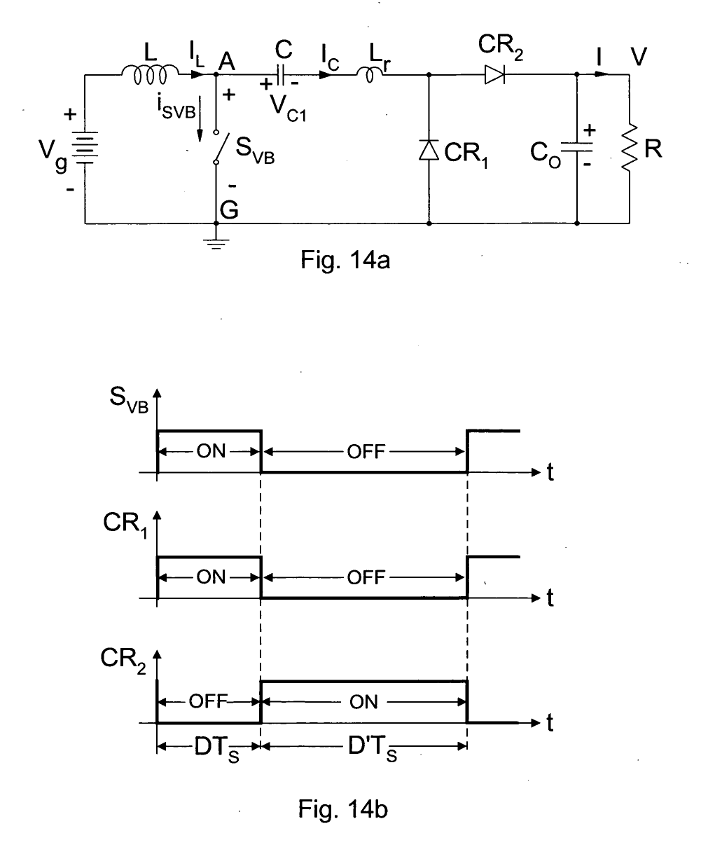

This operation is described with respect to converter circuit of FIG. 14a and corresponding state of the switches shown in FIG. 14b. Turning OFF of the controllable switch S_{VB} during OFF-time interval D'T_{S} forces the current rectifier CR₂ to conduct, which in turn, forces current rectifier CR₁ to turn-OFF. Subsequent turn-ON of S_{VB} switch during ON-time interval DT_{S} forces the current rectifier CR₁ to turn-ON and start conducting the resonant current during this interval. The turn-ON of current rectifier CR₁ forces the turn-OFF of current rectifier CR₂ by the positive output voltage V, which imposes reverse bias on this current rectifier. The detailed analysis in later section proves that the DC voltage conversion ratio is that of the step-up boost function given by

V/V_{g}=1/(1−D) (1)

Note that the switch S_{VB} conducts the current in the direction shown on FIG. 14a and blocks the voltage of the polarity indicated in FIG. 14a.
Operation from Negative Input Voltage Polarity

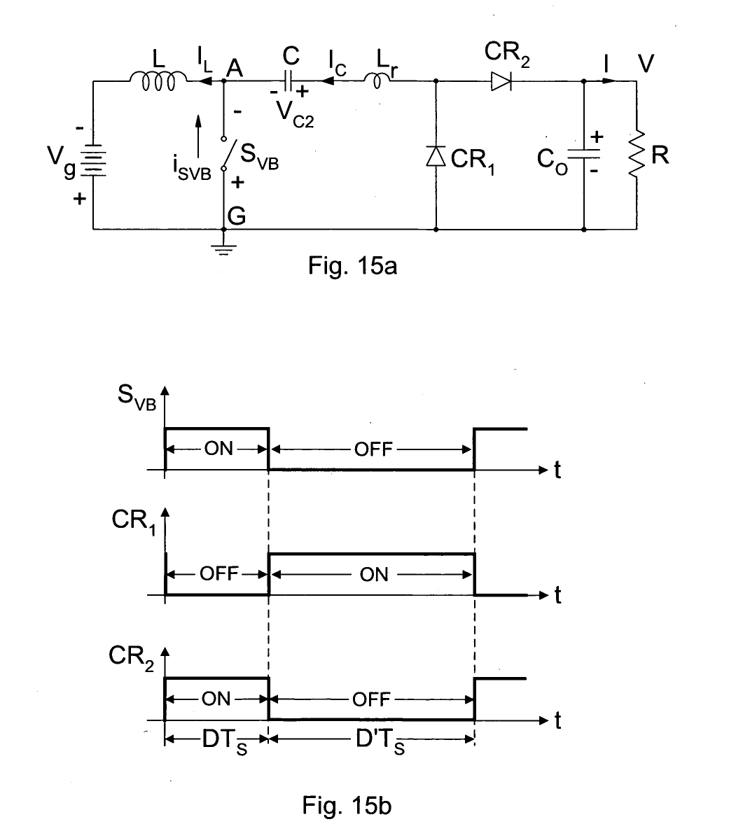

This operation is described with respect to converter circuit of FIG. 15a and corresponding state of the switches shown in FIG. 15b. Turning OFF of the controllable switch S_{VB} during OFF-time interval D'Ts forces the current rectifier CR₁ to conduct, which in turn, forces current rectifier CR₂ to turn-OFF. Subsequent turn-ON of S_{VB} switch during ON-time interval DT_{S} forces the current rectifier CR₂ to turn-ON and start conducting the resonant current during this interval. The turn-ON of current rectifier CR₂ forces the turn-OFF of current rectifier CR₁ by the positive output voltage V, which imposes reverse bias on this current rectifier. The detailed analysis in later section proves that the DC voltage conversion ratio for negative input DC voltage is that of the step-up boost function given by

V/V_{g}=1/(1−D) (2)

where now input DC voltage V_{g} has opposite polarity from the previous case. Thus, the single power processing stage of FIG. 11a and FIG. 11b converts the polarity changing input voltage into a positive polarity output DC voltage with the same DC conversion function.

Note that the switch S_{VB} conducts the current now in opposite direction as shown on FIG. 15a and blocks the voltage of the opposite polarity as indicated in FIG. 15a. Note also how the two current rectifiers automatically respond to the control imposed by the switch S_{VB} in such a way that their current direction is maintained the same for either polarity of the input voltage. However, they do automatically switch their conduction intervals for either polarity of the input DC voltage so as to form the resonant switching interval during ON-time interval of the controlling switch S_{VB} as explained in more details in subsequent analysis of a single polarity power processing stage.

### Resonant Interval

The converters in FIG. 14a and FIG. 15a operate by switching between two circuits defined as:

1. Resonant switching during the OFF-time interval D'T_{S};

2. Square-wave switching during ON-time interval DT_{S}.

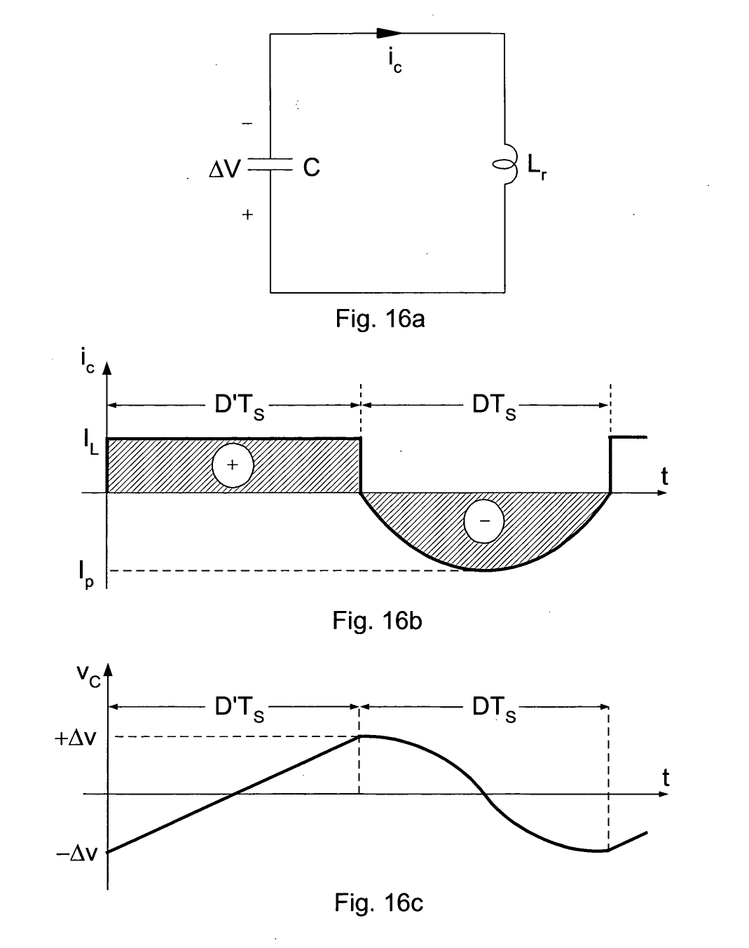

The resonant circuit can in each case be reduced to an equivalent circuit model shown in FIG. 16a, which results in the capacitor C current as illustrated in FIG. 16b. The capacitor C ripple voltage in FIG. 16c shows the resonant voltage waveform during OFF-time interval. The resonant circuit of FIG. 16a determines the resonant frequency and half the resonant period during during ON-time DT_{S}.

### Constant ON-Time and Variable OFF-Time Control

If the ON-time of the switch S_{VB} is equal to half of a resonant period, then the resonant discharge current waveform will be exactly half a sine wave. The best mode of operation is then to keep the ON-time constant as per:

T_{ON}=DT_{S}=Tᵣ/2=constant (3)

so that duty ratio is proportional to switching frequency, or:

$$\begin{matrix}D = {f}_{S} / 2 {f}_{r} & ( 4 ) \\ where \\ {ω}_{r} = \frac{1}{\sqrt{{L}_{r} C}} {f}_{r} = {ω}_{r} / 2 π & ( 5 )\end{matrix}$$

Thus, voltage regulation is obtained by use of the variable switching frequency f_{S}. However, this results in corresponding duty ratio D as per (4). Note that all DC quantities, such as DC voltages on capacitors and DC currents of inductors are still represented as a function of duty ratio D only, as in the case of conventional constant-switching frequency operation.

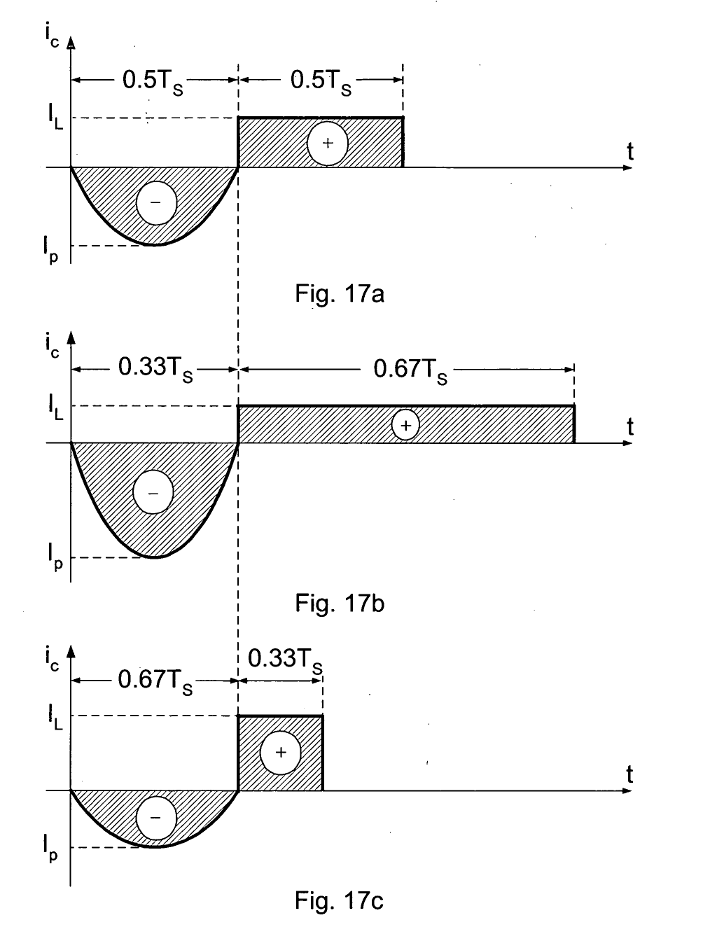

The waveforms of FIG. 17a, FIG. 17b, and FIG. 17c show the constant ON-time (interval DTₛ) displayed first to emphasize the variable OFF-time and variable switching frequency.

### Experimental Verifications

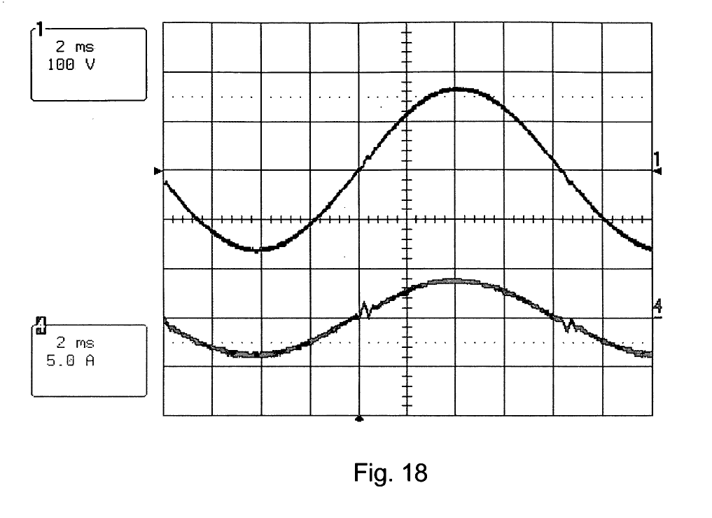

The Bridgeless PFC converter is verified by on an experimental 400W prototype, which converts 110V AC line voltage into a 400V DC output voltage. FIG. 18a shows the line voltage (top trace) and AC line current (bottom trace). The Power Factor was measured at 300 W load to be 0.997.

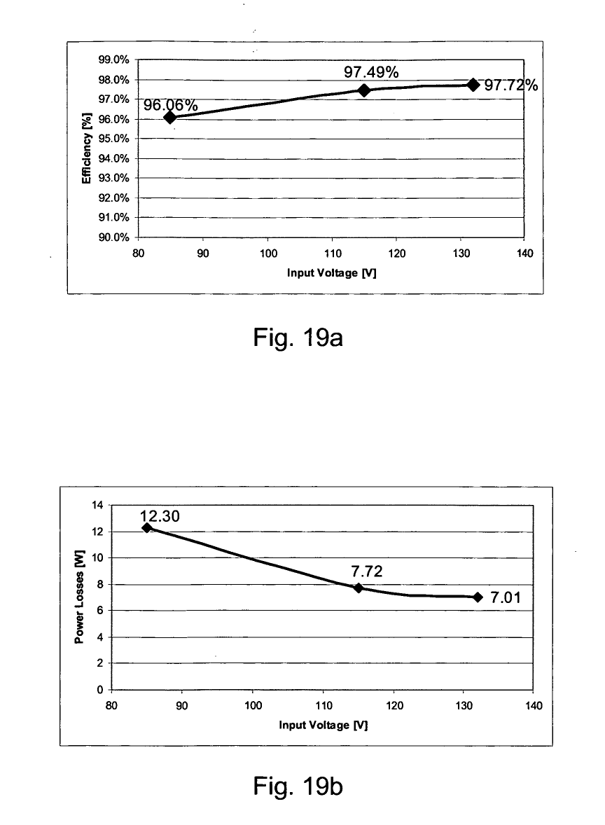

Very high efficiency of over 97% was measured over the wide input AC voltage range. In particular, note the very high efficiency at the low AC line voltage of 85VAC as shown in FIG. 19a while the power losses are shown in FIG. 19b. This clearly indicates the absence of the bridge rectifier on the front. The prior-art PFC converters have a significant efficiency drop at the low 85V AC line due to the two-diode voltage drops. This is clearly one of the key advantages of the new Bridgeless PFC converter.

### CONCLUSION

The true Bridgeless PFC converter is provided which eliminates the front end full-bridge rectifier altogether. Therefore, the present invention results in several basic advantages of this bridgeless PFC converter:

1. Higher efficiency due to complete elimination of the full-bridge rectifier and losses associated with it;

2. Reduction of the cost due to elimination of the bridge rectifier and associated heat-sink and reduced overall cooling costs due to higher efficiency;

3. Reduction of the size as bridge rectifier is eliminated along with its heat-sink;

4. Full utilization of all the components for both positive and negative part of the input AC cycle as there are no idle components in either cycle.

What is claimed is:

1. A switching DC-to-DC converter having a bipolar input DC voltage off either polarity (positive or negative) connected between an input terminal and a common terminal and providing power to a DC load of positive polarity connected between an output terminal and said common terminal said converter comprising:
an input switch with one end connected to said common terminal;
an inductor with one end connected to said input terminal and another end connected to said input switch another end thereof;
a branch comprising series connection of a capacitor and a resonant inductor, forming two ends of the branch, one being capacitor end and the other being resonant inductor end whereby capacitor end is connected to another end of said input inductor.
a first output switch comprising anode and cathode ends with anode end connected to said common terminal and cathode end connected to said resonant inductor end;
a second output switch comprising anode and cathode ends with anode end connected to said resonant inductor end and cathode end connected to said output terminal.
switching means for keeping said input switch ON for a duration of time interval DT_{S} and keeping it OFF for a complementary duty ratio interval D'T_{S}.
wherein said input switch is a controllable semiconductor voltage bi-directional switching device, capable of conducting the current in either direction while in an ON-state, and sustaining voltage of either polarity, while in an OFF-state;
wherein said first and said second output switches are semiconductor current rectifier switching devices controlled by both the state of the input switch as well as the polarity of the input DC voltage.
wherein said switching means of controlling ON and OFF time of the input switch cause the first and second output switches to either conduct or block the current depending on the polarity of the bipolar input voltage source so that the DC output voltage of the same positive polarity is obtained for either polarity of the input DC voltage source.
wherein a DC-to-DC voltage conversion ratio of said converter has identical DC voltage step-up characteristic as a function of operating duty ratio D for either polarity of the input bipolar DC voltage source.
wherein the resonant inductor and capacitor form a resonant circuit during ON time of the input switch for either polarity of the input DC voltage source, conducting only one half of the resonant sinusoidal current when the ON time of input switch is equal to the half the resonant period.
wherein the output DC voltage step-up is obtained by controlling the OFF-time of the input switch for either polarity of the input bipolar DC voltage source.

2. A converter as defined in claim 1,
wherein DC output voltage of negative polarity with respect to said common terminal is obtained by reversing the current direction in the two output semiconductor rectifier switches by exchanging their anode and cathode end connections.

3. A converter as defined in claim 1,
wherein the first and second output semiconductor rectifier switches are replaced by MOSFET switching transistors devices operated as synchronous rectifiers in order to reduce the conduction losses and increase the efficiency of the DC-DC conversion.

4. A converter as defined in claim 1,
wherein the voltage bi-directional input switch is implemented by use of the two n-channel MOSFET switching transistors connected in series and back to back so that their sources are connected together and their gates are connected together, while their drains are providing the end terminals of this composite switch replacing ideal four quadrant input switch.
wherein the common gate is driven by external means to turn ON and turn OFF input switch as in claim 1.

5. A converter as defined in claim 1,
wherein the input switch is implemented by a single MOSFET switching transistor which has a body diode disconnected so that it can conduct the current in either direction and block the voltage of either polarity whereby such implementation will result in increased efficiency.

6. A converter as in claim 1,
wherein the capacitor and resonant inductor are still connected in series, but have exchanged their position.

7. A direct AC-DC Converter without a bridge rectifier capable of providing a Power Factor Corrected input current with a near Unity Power Factor comprising of an AC input voltage source connected between an input terminal and a common terminal and providing the power to a DC load connected between an output terminal and a common terminal said converter comprising:
an input switch with one end connected to said common terminal;
an inductor with one end connected to said input terminal and another end connected to said input switch another end thereof;
a branch comprising series connection of a capacitor and a resonant inductor, forming two ends of the branch, one being capacitor end and the other being resonant inductor end whereby capacitor end is connected to another end of said input inductor.
a first output switch comprising anode and cathode ends with anode end connected to said common terminal and cathode end connected to said resonant inductor end;
a second output switch comprising anode and cathode ends with anode end connected to said resonant inductor end and cathode end connected to said output terminal.
a large storage capacitor connected between the output terminal and common terminal
the sensing means to sense the AC input current and AC input voltage
the switching means for keeping said input switch ON for a duration of time interval DT_{S} and keeping it OFF for a complementary duty ratio interval D'T_{S}.
the sensing means to sense the AC input current and AC input voltage.
the control means to control the OFF-time of the input switch as so as to make the AC input current proportional to AC input voltage so that near Unity Power Factor performance is achieved as well as low harmonics meeting regulation requirements are achieved.
wherein said input switch is a controllable semiconductor voltage bi-directional switching device, capable of conducting the current in either direction while in an ON-state, and sustaining voltage of either polarity, while in an OFF-state.;
wherein said first and said second output switches are semiconductor current rectifier switching devices controlled by both the state of the input switch as well as the polarity of the input DC voltage.
wherein said switching means of controlling ON and OFF time of the input switch cause the first and second output switches to either conduct or block the current depending on the polarity of the bipolar input voltage source so that the DC output voltage of the same positive polarity is obtained for either polarity of the input DC voltage source.
wherein a DC-to-DC voltage conversion ratio of said converter has identical DC voltage step-up characteristic as a function of operating duty ratio D for either polarity of the input bipolar DC voltage source.
wherein the resonant inductor and capacitor form a resonant circuit during ON time of the input switch for either polarity of the input DC voltage source, conducting only one half of the resonant sinusoidal current when the ON time of input switch is equal to the half the resonant period.
wherein the output DC voltage step-up is obtained by controlling the OFF-time of the input switch for either polarity of the input bipolar DC voltage source.
wherein the large capacitor between said output terminal and said common terminal reduces the output ripple voltage and stores the DC energy to provide required energy storage when AC line is interrupted for one or two cycles.

8. A converter as defined in claim 7,
wherein DC output voltage of negative polarity with respect to said common terminal is obtained by reversing the current direction in the two output semiconductor rectifier switches by exchanging their anode and cathode end connections.

9. A converter as defined in claim 7,
wherein the first and second output semiconductor rectifier switches are replaced by MOSFET switching transistors operated as synchronous rectifiers in order to reduce the conduction losses and increase the efficiency of the AC-DC conversion.

10. A converter as defined in claim 7,
wherein the voltage bi-directional input switch is implemented by use of the two re-channel MOSFET switching transistors connected in series and back to back so that their sources are connected together and their gates are connected together, while their drains are comprising the end terminals of this composite switch replacing ideal four quadrant input switch.
wherein the common gate is driven by external means to turn ON and turn OFF input switch as in claim 1.

11. A converter as defined in claim 7,
wherein the input switch is implemented by a single MOSFET switching transistor which has a body diode disconnected so that it can conduct the current in either direction and block the voltage of either polarity.
whereby such implementation will result in increased efficiency.

12. A switching DC-to-DC converter having a input DC voltage off positive polarity connected between an input terminal and a common terminal and providing power to a DC load of positive polarity connected between an output terminal and said common terminal said converter comprising:
an input switch with one end connected to said common terminal;
an inductor with one end connected to said input terminal and another end connected to said input switch another end thereof;
a branch comprising series connection of a capacitor and a resonant inductor, forming two ends of the branch, one being capacitor end and the other being resonant inductor end whereby capacitor end is connected to another end of said input inductor.
a first output switch comprising anode and cathode ends with anode end connected to said common terminal and cathode end connected to said resonant inductor end;
a second output switch comprising anode and cathode ends with anode end connected to said resonant inductor end and cathode end connected to said output terminal.
switching means for keeping said input switch ON for a duration of time interval DT_{S} and keeping it OFF for a complementary duty ratio interval D'T_{S}.
wherein said input switch is a single quadrant controllable semiconductor switching device, such as bipolar transistor or MOSFET transistor capable of conducting the current in one direction during ON state and blocking the voltage of one polarity while in an OFF state.
wherein said first and said second output switches are semiconductor current rectifier switching devices controlled by both the state of the input switch as well as the polarity of the input DC voltage.
wherein said switching means of controlling ON and OFF time of the input switch cause the first and second output switches to either conduct or block the current depending on the polarity of the bipolar input voltage source so that the DC output voltage of the same positive polarity is obtained for either polarity of the input DC voltage source.
wherein a DC-to-DC voltage conversion ratio of said converter has a voltage step-up characteristic as a function of operating duty ratio D.
wherein the resonant inductor and capacitor form a resonant circuit during ON time of the input switch for either polarity of the input DC voltage source, conducting only one half of the resonant sinusoidal current when the ON time of input switch is equal to the half the resonant period.
wherein the output DC voltage step-up is obtained by controlling the OFF-time of the input switch.
